(19) United States
(12) Patent Application Publication
(10) Pub. No.: US 2016/0071171 A1
(43) Pub. Date: Mar. 10, 2016

(54) SYSTEM AND METHOD FOR MANAGING AND OPTIMIZING PROVIDER-TO-PATIENT AND PROVIDER-TO-PROVIDER COMMUNICATIONS AND REFERRALS

(71) Applicant: TREATSPACE INC., Pittsburgh, PA (US)

(72) Inventors: Anthony R. CANCELLIERE, III, Pittsburgh, PA (US); Caren C. TOBIN, Pittsburgh, PA (US); Alexander Y. LIU, Pittsburgh, PA (US); Jamie L. KLOUSNITZER, Pittsburgh, PA (US); David S. HELON, Pittsburgh, PA (US); Ashley D. LATTA, Pittsburgh, PA (US)

(21) Appl. No.: 14/846,150

(22) Filed: Sep. 4, 2015

Related U.S. Application Data
(60) Provisional application No. 62/045,624, filed on Sep. 4, 2014.
(60) Provisional application No. 62/045,635, filed on Sep. 4, 2014.
(60) Provisional application No. 62/045,652, filed on Sep. 4, 2014.

(51) Int. Cl. G06Q 30/02; G06Q 10/06

(52) U.S. Cl. CPC G06Q 30/0282; G06Q 10/06398; G06Q 50/22

(57) ABSTRACT

The present invention integrates accurate healthcare practitioner profile information and user-generated data streams, to include patient experience feedback and health insurance payer cost and quality data, within a web portal to enable secure management of practice visibility on the Internet, facilitate communications between patients and their providers, and streamline referrals of patients to appropriate providers and practices. It does so using a platform that includes a performance analytics engine to analyze performance of providers/practices to whom patients have been referred to generate performance metrics for these provider/practices in essentially real time and combines these generated performance metrics with the accurate healthcare practitioner profile information and user-generated data streams, to enable automatic and/or more focused future referrals which take into account the performance metrics.

### CROSS-REFERENCE TO RELATED APPLICATIONS

This application is based on, and claims priority to U.S. Provisional Application No. 62/045,624, filed Sep. 4, 2014; U.S. Provisional Application No. 62/045,635, filed Sep. 4, 2014; and U.S. Provisional Application No. 62/045,652, filed Sep. 4, 2014, the entire contents of each of which being fully incorporated herein by reference.

### FIELD OF THE INVENTION

The present invention integrates accurate healthcare practitioner profile information and user-generated data streams, to include patient experience feedback and health insurance payer cost and quality data, within a web portal to enable secure management of practice visibility on the Internet, facilitate communications between patients and their providers, and streamline referrals of patients to appropriate providers and practices. More particularly, the invention comprises a platform that includes a performance analytics engine to analyze performance of providers/practices to whom patients have been referred to generate performance metrics for these provider/practices in essentially real time and combines these generated performance metrics with the accurate healthcare practitioner profile information and user-generated data streams, to enable automatic and/or more focused future referrals which take into account the performance metrics.

### BACKGROUND OF THE INVENTION

A “Transition of Care” is the movement of a patient from one setting of care (hospital, ambulatory primary care practice, ambulatory, specialty care practice, long-term care, home health, rehabilitation facility) to another. At a minimum this includes all transitions of care and referrals that are ordered by an eligible provider (EP) such as a primary care physician (PCP).

Currently, the provider transition of care, otherwise known as the “referral process,” is unmanaged, and online information about providers is fragmented across a wide variety of confusing and erroneous or out-of-date websites, databases, rating sites and poorly managed web registries. There is no current system that manages certified and verified facts about providers, handles transitions of care which are optimized for quality and cost, and connects disjointed providers and patients across unconnected electronic health record systems.

Further, the United States Centers for Medicare and Medicaid Services (CMS) provides incentive payments to eligible professionals, eligible hospitals, and critical access hospitals (CAHs) as they adopt, implement, upgrade or demonstrate meaningful use of certified electronic medical health record (EMR) technology. Specifically, Meaningful Use Core Measure 15 of 17 (Summary of Care), last updated August 2015, requires the following: “Exchange a summary of care with a recipient who has EMR technology that was developed and designed by a different EMR technology developer than the sender's EMR technology.

In addition, the United States National Committee for Quality Assurance's (NCQA) Patient Centered Medical Home (PCMH) program provides quality incentive payments to primary care practices for operating as a “patient centered medical home.” The patient-centered medical home is a way of organizing primary care that emphasizes care coordination and communication to transform primary care into “what patients want it to be.” Medical homes can lead to higher quality and lower costs, and can improve patients' and providers' experience of care.

In order to be designated as a Patient Centered Medical Home (PCMH), “Referral Tracking” is a required element of the referral process and is comprised of the following items: (1) The practice considers available performance information on consultants/specialists when making referral recommendations; (2) The practice has the capacity for electronic exchange of key clinical information and provides an electronic summary of care record to another provider for more than 50 percent of referrals; (3) The practice tracks referrals until the consultant or specialist's report is available, flagging and following up on overdue reports; (4) Exchanges key clinical information with facilities and provides an electronic summary-of-care record to another care facility for more than 50 percent of patient transitions of care.

While primary care providers, hospitals and specialists are being incented to make “meaningful use” of their EMRs while ensuring patient Transitions of Care of sent electronically to ensure proper referral management for NCQA and PCMH standards, the responsibility to make meaningful use, operate as patient centered medical home, and universally connect all healthcare providers regardless of EMR technology falls on the physician practices, which they are ill-equipped to handle.

At the same time, social networks are being used to connect hundreds of millions of people. Consumers use Facebook® friendships, LinkedIn® connections, Twitter® trends and Pinterest® pins to supplement and broaden personal relationships and discover new interests.

Unfortunately, for the most part, health care enterprises have been left behind in the on-line experience. What is needed is a reliable, legal, and secure way to directly connect patients, providers, administrators and other health care stakeholders on-line.

A patient attempting to contact a healthcare practitioner may encounter difficulty if misled by unverified or inaccurate practitioner profile information. Practitioner profile information may include contact information, qualifications, area of specialty, and other facts about the practitioner. Profile information may be widely available through multiple sources on the Internet or stored in practitioner referral networks. Such wide availability of unverified and inaccurate profile information may prevent patients from contacting practitioners and hinder the ability of practitioners to refer patients to appropriate specialists.

The problem is compounded by the fact that a practitioner may not have taken part in the input of profile information or may not have any knowledge that the practitioner's profile information is being exhibited. It is therefore an object of the present invention to provide a system and method for service providers, such as healthcare practitioners, to manage, update, and verify their profile information through a cloud-based web application.

In addition, currently, there is no simple and reliable way for a service provider, such as a healthcare practitioner, to solicit feedback from patients about their healthcare experience and interact with such patients based on the content of the feedback. Healthcare practitioners typically gather feedback information from patients through pen and paper surveys or online surveys located on third-party websites. These existing survey systems, however, have low participation rates and do not organize the content of the feedback to facilitate communication between practitioners and patients.

The problem is further compounded by the fact that existing surveys are typically lost, ignored, or forgotten about by the patients, and practitioners have no reliable method to track feedback or to address meaningful complaints. Additionally, no central hub exists from which a practitioner may perform content-based analyses on any reported feedback. It is therefore an object of the present invention to provide a system for service providers, such as healthcare practitioners, to simply and reliably solicit, maintain, and respond to feedback of users or patients.

In addition to the various objects and advantages of the present invention which have been described above, various other objects and advantages of the invention will become more readily apparent to those persons skilled in the relevant art from the following more detailed description of the invention, particularly, when such description is taken in conjunction with the attached drawing figures and with the appended claims.

### SUMMARY OF THE INVENTION

The present invention includes an integrated referral management, clinical collaboration, and patient engagement platform, comprising: a referring provider module, a referred provider module, and a patient module, interconnected with each other via a network connection; a decision support engine coupled to the referring provider module, referred provider module, and patient module, the decision support engine identifying referral suggestions and outputting a list of said referral suggestions; a workflow management module coupled to receive referral recommendations selected from the list of referral suggestions developed by the decision support module; a performance analytics module coupled to the workflow management module, generating performance data based on performance of the referral recommendations; and a feedback module coupled to receive patient feedback from the patient feedback module and generating patient feedback data; the performance data and patient feedback data being routed into the decision support engine, whereby the decision support engine adjusts its referral suggestions in real time based on all inputs it receives.

The methods and systems of the present invention provide a decision support tool that evaluates insurance, geography, availability, specialty, expertise and patient preference data to identify optimal providers for specialty referrals. Reimbursement for services provided is maximized because care is coordinated amongst providers and patients are engaged with their health care providers via a secure communication system.

In an embodiment, the methods and systems are provided that enable a provider's office staff to utilize its time more efficiently since the practice uses the system to refer its patients to a select group of practitioner partners who meet their (or other predetermined) standards for coordinated care and the physicians/practices to whom the patients have been referred can use the system to quickly and automatically advise that care was provided and automatically provide the originating office with any additional feedback or other documentation they need to maintain a high level of patient care and efficiency.

In another embodiment, a secure communication link is created between the originating provider and the referred provider, as well as between providers and their patients on-line. Thus, providers can better manage referrals to other providers and collaborate with those providers to manage and improve care for a particular patient. At the same time, patients can be more engaged in their own care.

In still another embodiment, practices can create and customize their own branded websites using the disclosed system. Content placed on the website is easily managed by the practice without having to manage any servers or architecture. Further, practices can place portal links on their website to enable patients to have easy access to pertinent information such as billing and medical records.

In another embodiment, online social networking aspects are made available to patients and providers. Patients or providers have the opportunity to follow other practices or providers so that they are notified of contact or credential changes. Also, providers can send short text-based updates to their followers. Patients or other providers can also post comments to profiles created by providers using the system of the present invention.

The accurate and verified healthcare practitioner profile information is now available to inform patients and as an input to the invention's decision support system to facilitate optimized referral management.

The patient feedback is also available as a real-time input to the invention's decision support system to facilitate optimized referral management in a manner that is unable to be performed with current technology.

### BRIEF DESCRIPTION OF THE DRAWINGS

The present invention is illustrated by way of example, and not limitation, in the figures of the accompanying drawings, in which:

FIG. 1 illustrates an embodiment of the communication system in accordance with the present invention.

FIG. 2 illustrates the features of the system that a referring health-care provider will have access to in accordance with the present invention.

FIG. 3 illustrates the features of the system that a referred health-care provider will have access to in accordance with the present invention.

FIG. 4 illustrates the features of the system that a patient using the system will have access to in accordance with the present invention.

FIG. 5 is an illustration of a practice portal aggregator, as seen by a patient user, constructed in accordance with an embodiment of the invention.

FIG. 6 is an illustrative graphical representation of the method of referral management as set forth by the invention.

FIG. 7 is a flow diagram illustrating the input and verification of a practitioner's profile information.

FIG. 8 is an illustration of a badge certifying that a practitioner's information has been verified in accordance with an embodiment of the present invention.

FIG. 9 is a schematic illustration of a system for soliciting, maintaining and responding to feedback.

### DETAILED DESCRIPTION OF THE INVENTION

The system and method of the present invention is a HIPAA compliant, web-based platform that hosts third party web applications that facilitate interaction and information transmission and analysis between two or more parties of medical and/or healthcare content. There are three major components: referral management, clinical collaboration, and patient engagement.

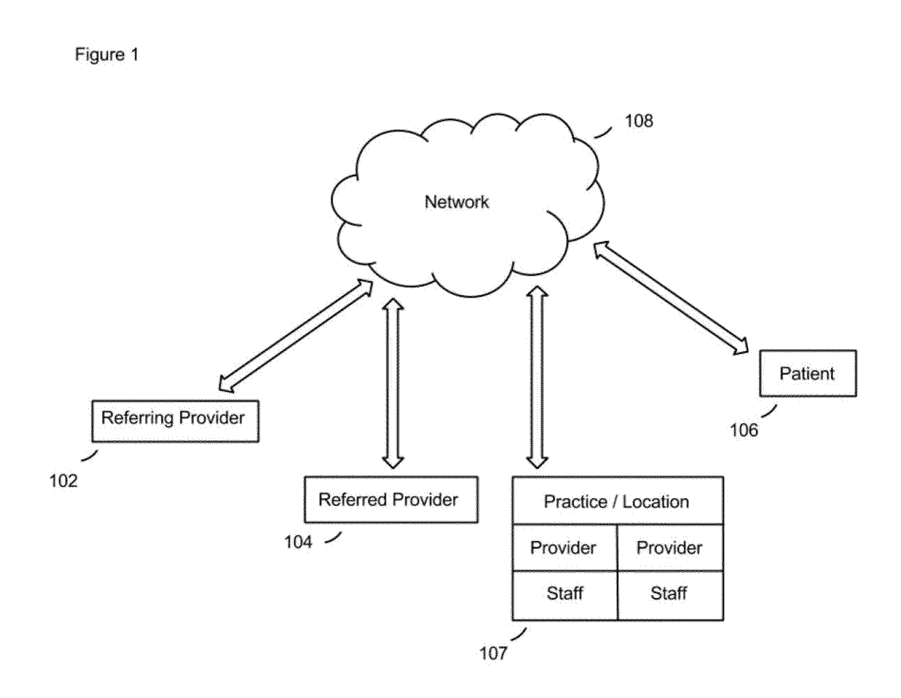

Referring now to the figures, FIG. 1 illustrates an example arrangement of network communications among patient users 106, their primary provider (referring provider) user 102, a specialist provider (referred provider) user 104, such as may be referred for the patient user 106 by the primary provider user 102, and a practice and its locations 107, each of which can comprise a group of providers and their associated staff. It will be apparent to those of skill in the art of networking and computers that each of the providers and patients will access the Network 108 in a typical way such as through a general purpose computer having an internet connection using standard communication protocols, a phone or tablet having a wireless connection to the internet or having a connection through a cellular or mobile phone transmission protocol. FIG. 1 is intended to be representative only and is not intended to limit the scope of the invention.

Those of skill in the art will also immediately recognize that the system and method of the present invention is computer-implemented in that it will be performed through the use of software that contains instructions to direct a processor to perform certain tasks, access certain databases, generate certain user interfaces and communicate with other computers via a network and, most likely, the Internet.

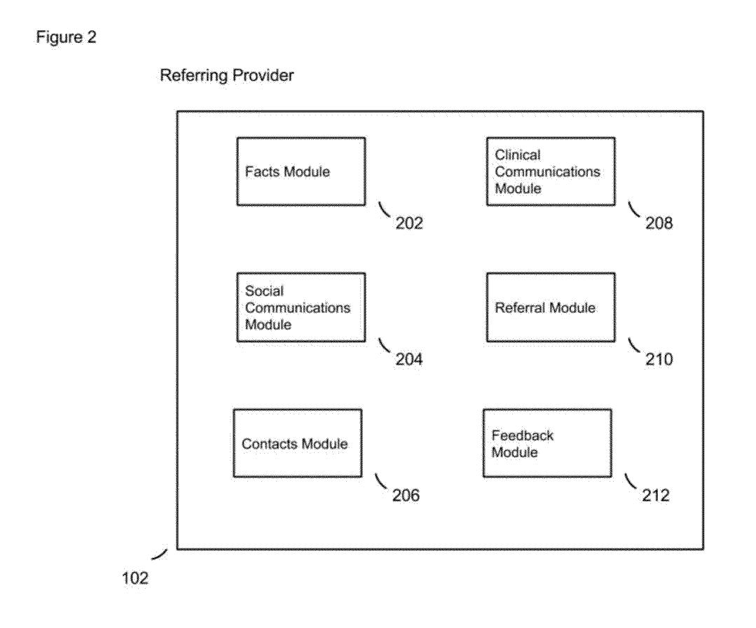

Referring now to FIG. 2, the components of the system that are available to the primary provider user 102 are shown. A facts module 202 allows providers to accurately display facts about their education, experience, insurance alignments, and other optional biographical information to viewers of their public profile. This public profile will be accessible to all who access the system through the Internet, not just those who are registered users. Optionally, facts used by this module can be verified by the provider and/or certified by a third party for accuracy. In another embodiment, this module can also contain links that connect patients to Patient Portal Websites including, but not limited to, an EMR site where the patient can view their records and perform actions such as requesting medication refills or a Patient On-line Bill Pay site where the patient can view and pay any outstanding invoices.

A social communications module 204 allows providers to create a social communication link between themselves and their patients. Through blogs, micro-blogs, and education documents created by the user or a third party, providers can maintain communication with all of their patients at once to maintain a form of constant, or at least constantly available, communication. Another embodiment of the social communications module leverages the social media technology to encourage patients to receive necessary and recommended medical care.

For a provider, a contacts module 206 lists networked connections made between themselves and patients and other providers.

A clinical communications module 208 is a HIPPA compliant secure messaging system. The messages communicated along this system are encrypted so that Personal Health Information (PHI) is transmitted safely and securely between patients and their providers. Whereas instant message (IM) based communications and email messages are not necessarily encrypted, the messages sent via the clinical communications module 208 can be securely transmitted between providers and patients using known techniques.

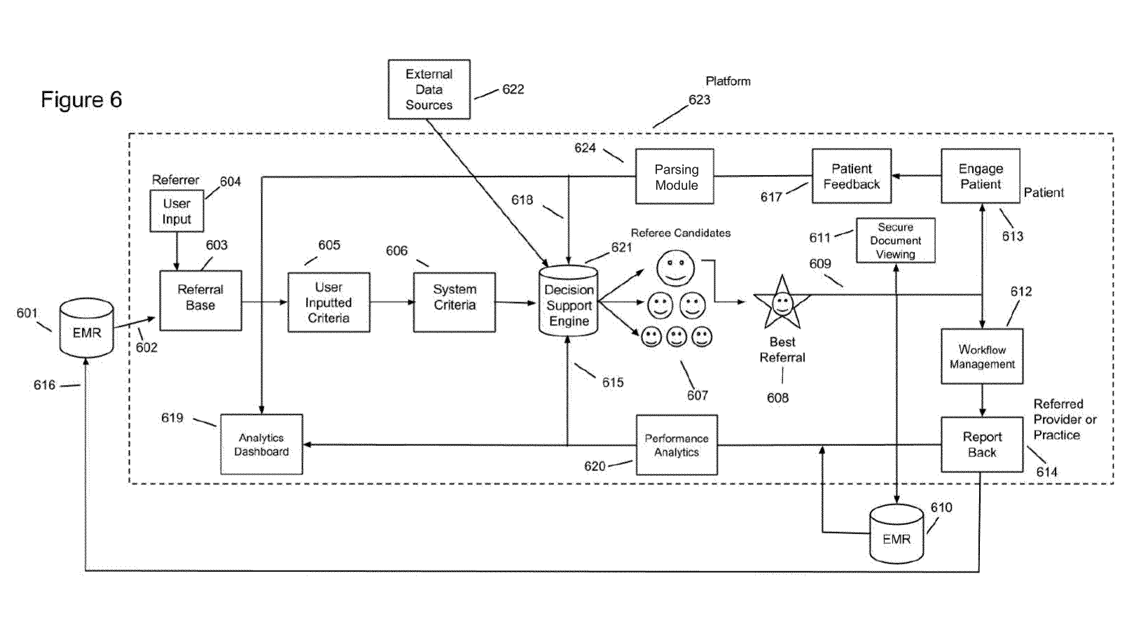

A referral module 210 is a system that enables the creation of referrals between healthcare providers and provides the ability to track and analyze them. The referral module 210 includes a decision support engine configured to analyze available referral partners in a specialized database to allow the healthcare provider to choose the best referral option given a wide variety of relevant inputs (discussed further herein) that cannot be considered and analyzed by current methodologies. The referral module 210 then sends an electronic encrypted referral message as well as relevant documents from an EMR to another practice or provider through the system using proprietary and industry standard protocols such as Direct Secure Messaging (DSM). The decision support mechanism (described in more detail with respect to FIG. 6) analyzes and ranks referral partners based on criteria that includes, but is not limited to, medical specialty, geographic location, insurances accepted, quality scores defined by relevant metrics, cost data, system generated performance data, and qualitative and quantitative patient feedback gathered in a feedback module 212. Once created and sent, a referral can be tracked, securely discussed, and closed when the system receives an indication that the patient has seen the referral provider and, optionally, when relevant documents from an EMR or other pertinent information have been sent back to the referring provider.

The feedback module 212 is configured to automatically send requests to patients for patient feedback after any pre-selected qualifying event. These events may be office visits, visits to other practices or providers, e-visits, and any other such triggering events. Patients can either respond to these automatically generated requests for qualitative and quantitative feedback, or initiate qualitative or quantitative feedback on their own.

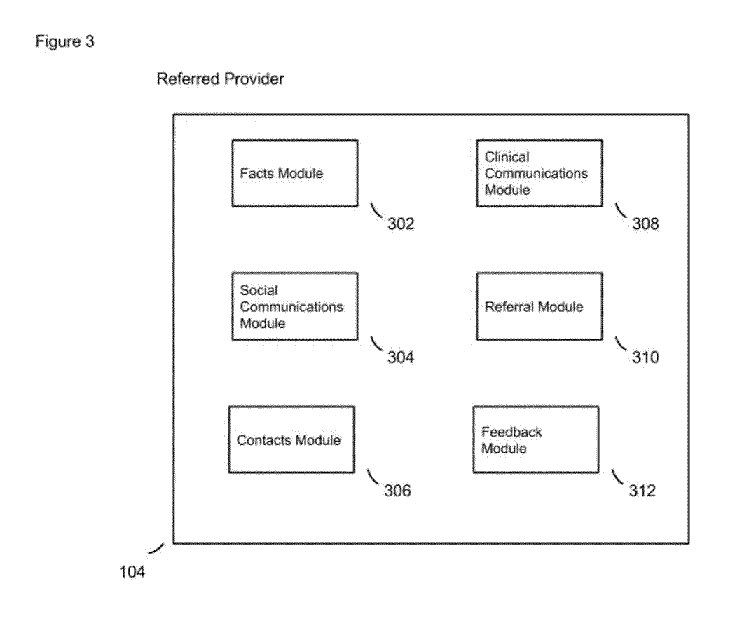

FIG. 3 illustrates the communication components of the inventive system that a referred provider might have access to by accessing their account on the website. These components are essentially the same as those illustrated for the referring provider in FIG. 2. A referred provider facts module 302 permits providers to input accurate facts regarding education, experience, and insurance alignments, as well as biographical information for viewers of their public profile. This public profile will be accessible to all website visitors. Optionally, facts within this module can be verified by the provider and/or certified by a third party for accuracy. In another embodiment, the information provided referee facts module 302 is input into a decision support engine in referral module 310.

A social communications module 304 allows referred providers to create a social link between themselves and their patients. Through blogs, micro-blogs, and user created education documents, referred providers can maintain communication with all of their patients at once to maintain a form of constant (or constantly-available) communication. Another embodiment of the social communications module leverages the social media technology to encourage patients to receive necessary and recommended medical care.

For a referred provider, a contacts module 306 lists the networked connections made between themselves and patients and other providers, such as referral sources.

A clinical communications module 308 is a HIPAA compliant secure messaging system. The messages communicated along this system are encrypted so that Personal Health Information (PHI) is transmitted safely and securely between patients and their providers. Whereas cell phone text-based communications and standard email messages are not encrypted, these messages can be securely transmitted between providers and patients.

The referral module 310 is a system that enables the receiving of referrals between healthcare providers and provides the ability to track and analyze them. The referral module 310 then confirms receipt of the electronic encrypted referral and any relevant documents from an EMR from another practice or provider through the system using proprietary and industry standard protocols such as DSM. Once received, a referral can be tracked, securely discussed, and closed when the patient has seen the referred provider and, optionally, when relevant documents from an EMR or other pertinent information have been sent back to the referring provider.

A feedback module 312 is configured to automatically send requests for patient feedback after any pre-selected qualifying event. These events may be office visits, visits to other practices or providers, e-visits, and any other such triggering events. Patients can either respond to these automatically generated requests for qualitative and quantitative feedback, or initiate qualitative or quantitative feedback on their own.

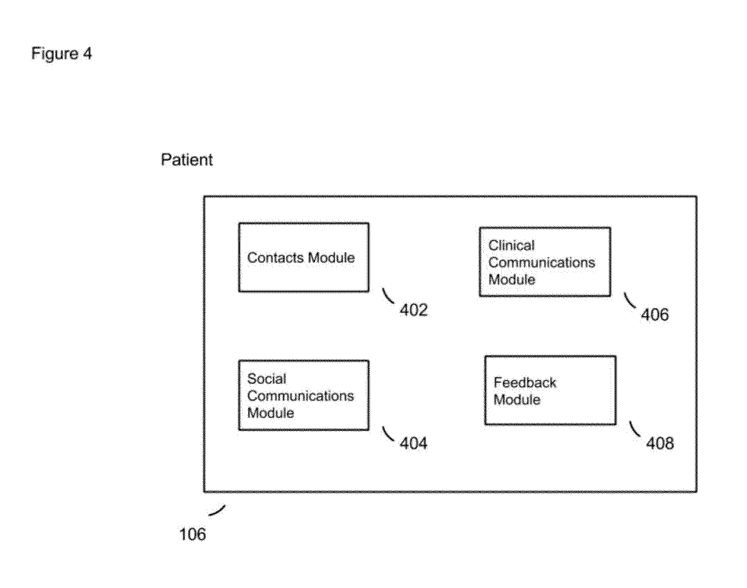

FIG. 4 schematically illustrates communication components of a website to which a patient member has access. For a patient, a contacts module 402 lists the networked connections made between themselves and providers. A social communications module 404 allows patients to follow and read, in an aggregated way, the blogs and micro-blogs of entities such as providers, practices, and locations. This so-called “newsfeed” keeps users up to date with relevant messaging and the latest health information from the users or organizations they follow. Another embodiment of the social communications module 404 leverages social media technology to encourage patients to receive necessary and recommended medical care.

A clinical communications module 406 is a HIPAA compliant secure messaging system. The messages communicated along this system are encrypted so that Personal Health Information (PHI) is transmitted safely and securely between patients and their providers. Whereas cell phone text-based communications and standard email messages are not necessarily encrypted, these messages can be securely transmitted between providers and patients.

A feedback module 408 automatically sends requests for patient feedback out after any qualifying event. These events may be office visits, visits to referred providers or practices, e-visits, and any other such triggering events. Patients can either respond to these automatically generated requests for qualitative and quantitative feedback, or initiate a qualitative feedback on their own.

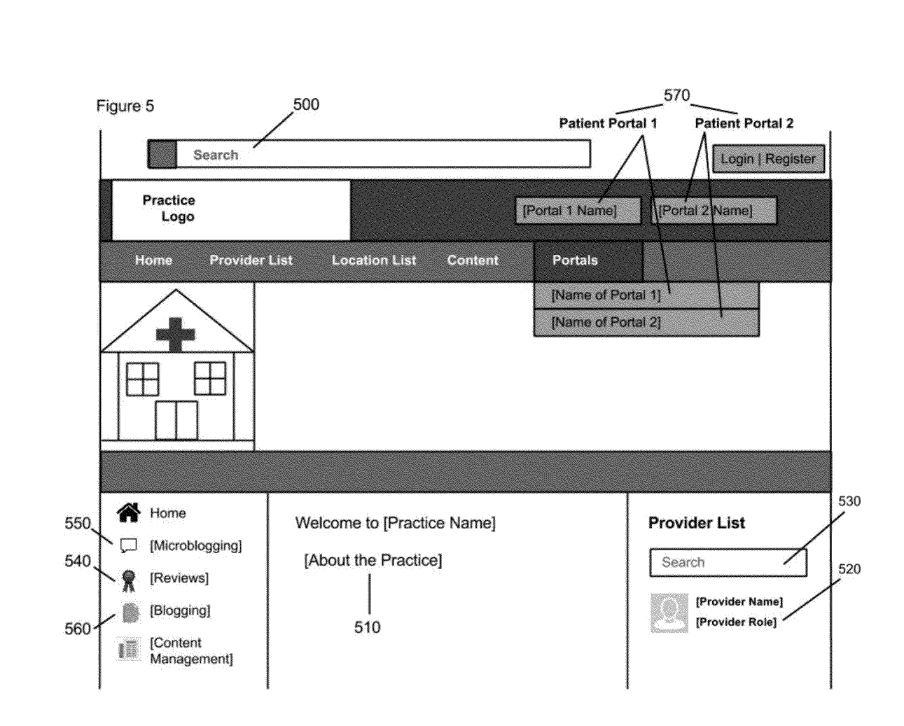

FIG. 5 is an illustration of an embodiment of a practice portal aggregator page 500, as seen by a patient user, constructed in accordance with the invention. The page can provide some descriptive information 510 about a practice group, including contact information, addresses, and care team members 520. Using a search box 530, a user is able to search for a specific member on the care team, as well as sort the care team members with specific parameters. Further, the practice and the care team members can have reviews written about them and also associated with them, as displayed under Kudos 540. Further, providers in the practice can provide updates about their area of expertise or clinical focuses via the Microblogging 550 or Blog 560 facilities. These features enable a patient to get detailed and updated information about every aspect of the practice. Patient portals 570 are also aggregated and displayed, making it easy for patients to find and access them.

In certain embodiments, the system of the present invention also allows healthcare professionals and companies to utilize standardized communication protocols to connect proprietary and exclusive information systems to a non-exclusive web-based platform to have compliant interactions between entities such as systems, organizations, professionals, and patients. The system provides a way for users to review and synthesize data that would otherwise be unavailable and non-aggregated on the web.

In an alternative embodiment, the disclosed system not only provides a web application development test environment, but also features a “tool box” that provides third party developers with guidelines, tools, sample code, and restrictions to allow the development and testing of normal and HIPAA compliant web applications utilizing the underlying infrastructure and data of the disclosed system without the requirement of a third party to maintain in-house HIPAA compliant systems and/or technologies. These applications can be monetized by their creators and used by other users of the system.

FIG. 6 shows a diagram representing a typical referral process and platform 623 according to the claimed invention. The referring provider or practice (referrer) generates necessary files, including but not limited to transition of care documents, in their EMR or similar system 601 and securely sends them via industry standard protocols such as DSM 602 to the platform 623. The platform 623 then parses the document and uses it to create the basis of the referral 603. Optionally, if the referrer does not have an EMR or similar system, the basis of the referral, which can consist of but is not limited to patient demographic information, reasons for referral, urgency, or diagnostic information, can be created on the platform by user input 609 entered by the referrer. The user then provides the system with user inputted criteria 605 including but not limited to preferred location of the referral (town, city, neighborhood, etc.), insurance available, and specialty of the referred provider or practice. System criteria 606 is then added, which can include but is not limited to the referred provider or practice's affiliation and facts (from referral provider facts module 302 of FIG. 3, for example), external data sources for quality scores defined by relevant metrics, and cost data 622, system generated performance data (performance analytics 620) if available, and qualitative and quantitative patient feedback 617 (if available) parsed by parsing module 624 (and output therefrom as parsed patient feedback criteria 618). Parsing module 624 is a processor configured to analyze the data to determine whether the feedback is positive or negative and can alert the practice if action is needed (i.e. for reaching out to the patient for negative feedback), and it can give a quantitative value to qualitative data so that it can be incorporated into future referral decisions

A decision support engine 621 analyzes the user inputted criteria 605, system criteria 606, parsed patient feedback criteria 618, system generated performance data 615 generated by the performance analytics engine 620, and external data sources for quality and cost data 622 to output a tiered e.g., good, better, best) list of candidates to receive the referral 607. The referring practice or provider utilizes this decision support tiered results to choose the best provider or practice for the patient's needs 608. The referral is then securely sent to the referred provider or practice and patient through a combination of proprietary and industry standard protocols such as DSM 609. If the referee has an EMR-like system and the referrer sent documents from their EMR to the platform, it will securely forward the documents to their EMR allowing the clinical information to be consumed into the patient's chart for better coordinated care 610. If they don't have one, they can view the contents on the secure document viewing platform 611. The referred provider or practice uses the platform workflow management engine 612 (e.g., a dashboard) to manage the workflow of the new referral, such as to set or change appointment dates, update the status of the referral, or to communicate with the referrer. The patient is engaged (613), e.g., with information about their referral and referred physician or practice and sent appointment reminders. When the referral is complete, the referred practice or provider updates the status of the referral using the platform workflow management engine/dashboard 612 and reports back (614) to the referrer with consult information which can include an updated med list, visit summary, or diagnostic information. Information gathered from the referral, such as time until appointment scheduled or cost, is fed back into the system criteria 606. If the referring provider or practice has an EMR, the appropriate documents from the referee will be forwarded on to the referrer's EMR (616). The Patient Feedback module 617 will circle back with the patient and gather quantitative and qualitative feedback about their experience. This feedback is fed back into the system criteria in real time (618). The platform gathers system performance analytics (620) that are integrated into the system criteria and included on a display in which the referrer can view analytics across that provider or practice's referrals in the analytics dashboard (619). These metrics could include number of referrals created per provider or location, number of referrals sent to each provider or practice, average time each provider takes to accept or complete referrals, or referees' compliance rate in sending back appropriate documentation.

It is contemplated that the presently described system will work in concert, and as part of, an on-line web portal that not only provides information about the physicians at a particular medical practice through the use of a practice website, but also facilitates referrals to specialists, enhances secure doctor to patient communication outside the limited parameters of an office visit. Additionally, the web portal provides access to third-party services such as providing access to the patient's electronic medical records or permitting payment of invoices via on-line bill pay facilities. The present system supplements the capabilities of the web portal by ensuring that available information about a physician or practice is accurate.

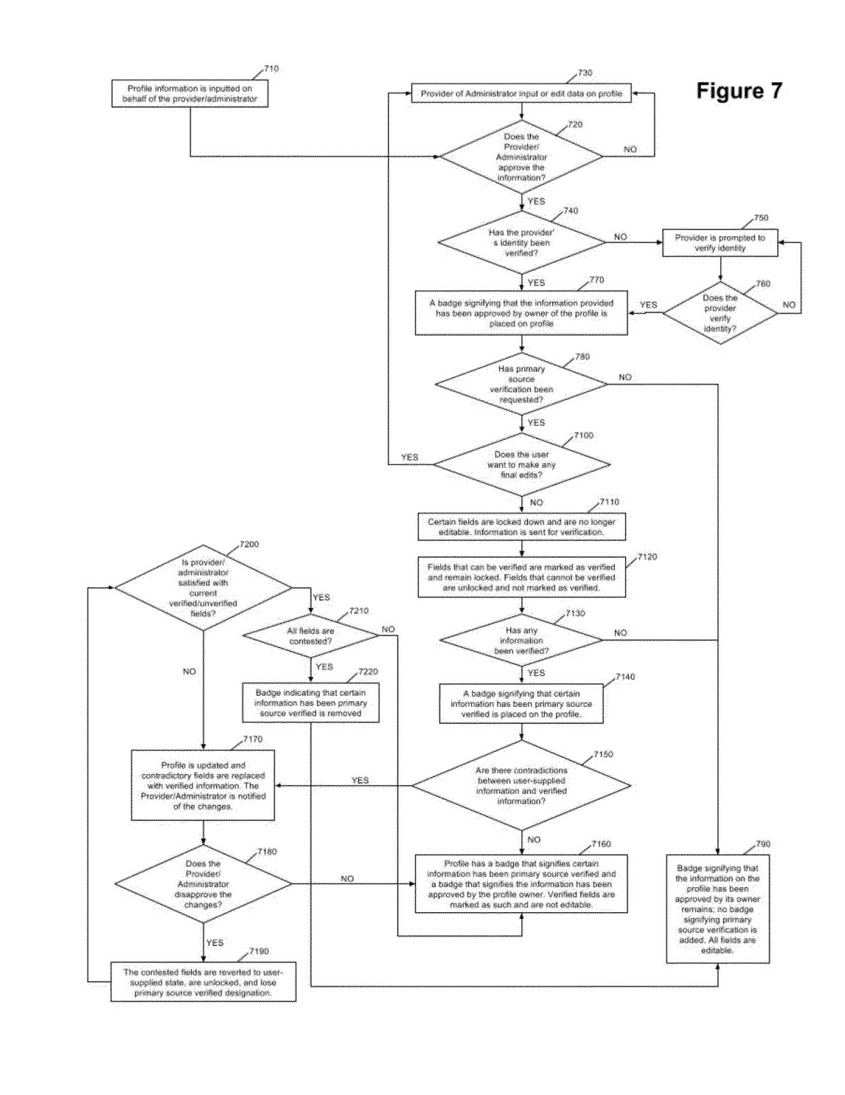

FIG. 7 is a flowchart illustrating the Facts Module. Referring to FIG. 7, profile information may be input by, or by an Administrator on behalf of, a healthcare provider (710) into appropriate data fields. Approval of the information is then sought from the provider/administrator (720). If the provider does not approve of the information, the provider may input or edit data on the profile (730) and approval would again be sought from the provider (720). Provider approval further requires that the provider's identity has been verified (740). If the provider's identity has not been verified, then the provider will be prompted to verify her identity (750). The system will again check whether the provider's identity has been verified (760) and may again prompt the provider to verify her identity (750) if it has not yet been verified.

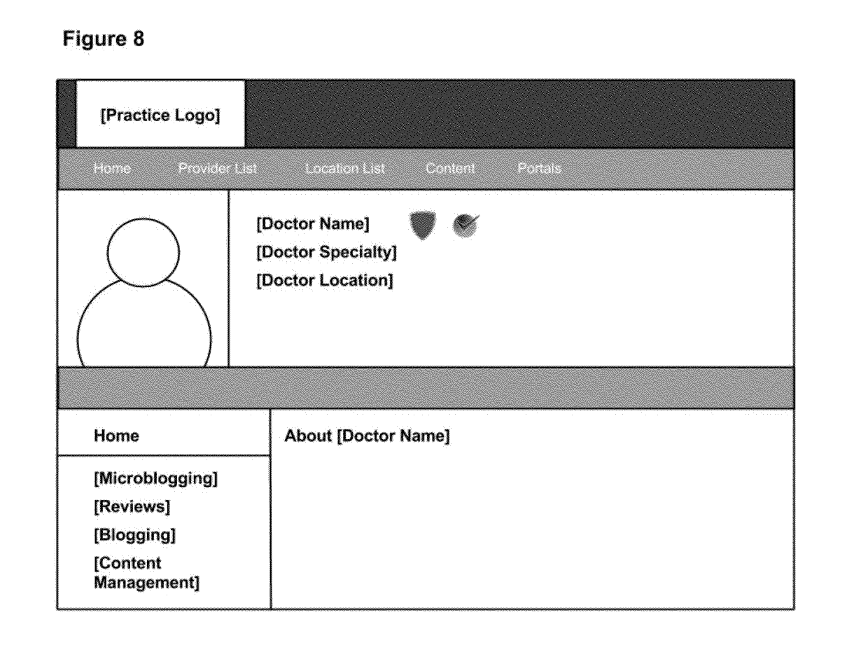

Once the provider's identity has been verified, a badge signifying that the information provided has been approved by the owner of the profile is placed on the profile (770). An example of a badge of the present invention displayed in a user interface is illustrated in FIG. 8. The system will then determine whether primary source verification (i.e., verification by the colleges, medical schools, etc.) has been requested (780). If primary source verification has not been requested, then the badge signifying that the owner of the profile has approved the profile information will remain and no additional badge signifying primary source verification will be added. In an embodiment, all fields will then remain editable (790) until primary source verification is requested. If primary source verification has been requested, then the practitioner must determine whether to make any final edits to the profile information (7100). If the practitioner decides to make further edits, the process proceeds back to step (730) and follows the process as explained above. If the practitioner does not wish to make further edits, then certain fields become locked and the information is sent for verification (7110).

Fields that can be verified remain locked and are marked as verified, while fields that cannot be verified are unlocked and are not so marked (7120). The system will then determine whether any information has been verified (7130). If no information has been verified, the badge signifying that the owner of the profile has approved the profile information will remain, no badge signifying primary source verification will be added, and all fields will remain editable (790). If information has been verified, then a badge signifying that certain information has been primary source verified is placed on the profile (7140). The system will then check whether contradictions exist between practitioner-supplied information and primary source verified information (7150). If no such contradictions exist, then the profile will have a badge signifying certain information has been primary source verified, a badge signifying the information has been approved by the profile owner, and verified fields will be marked and will not be editable (7160). If such contradictions do exist, then the profile is updated by replacing contradictory fields with verified information and the practitioner is notified of the changes (7170). Upon notification, the practitioner will be prompted to review and approve or disapprove of the changes (7180). If the practitioner approves of the changes, then the profile will have a badge signifying certain information has been primary source verified, a badge signifying the information has been approved by the profile owner, and verified fields will be marked and will not be editable (7160). If the practitioner disapproves of the changes, then contested fields become unlocked and lose primary source verified designation (7190).

The practitioner will then be prompted to determine whether she is satisfied with the current verified and unverified fields (7200). If the practitioner is not satisfied, then the profile is again updated by replacing contradictory fields with verified information and the practitioner is notified of the changes (7170) as explained above. If the practitioner is satisfied, the system will determine whether all of the fields are contested (7210). If some of the fields are uncontested, then the profile will have a badge signifying certain information has been primary source verified, a badge signifying the information has been approved by the profile owner, and verified fields will be marked and will not be editable (7160), as explained above. If all of the fields are contested, then the badge indicating that certain information has been primary source verified is removed (7220). In that case, the badge signifying that the profile information has been approved by the owner of the profile will remain, no badge signifying primary source verification will be added, and all fields will remain editable (790).

In one embodiment, the system previously described may be implemented through a web portal. Through this web portal, the practitioner approval of input profile information would result in the appearance of a badge or icon that represents that the owner of the profile has approved the content. A second badge or icon indicating primary source verification would appear following verification performed by a system administrator. Once in place, the primary source verification badge would remain so long as verified information entry fields remained locked and unedited.

In an alternative embodiment, the system may identify unverified or inaccurate practitioner profile information by finding practitioner profiles on third party websites. Instances of such profile information may be gathered and shared with the practitioners via a graphical user interface.

In another embodiment, the fields entered in the provider profile can be used as inputs into the decision support engine from the referral modules 210 and 310 as can best be seen in FIG. 2 and FIG. 3 respectively.

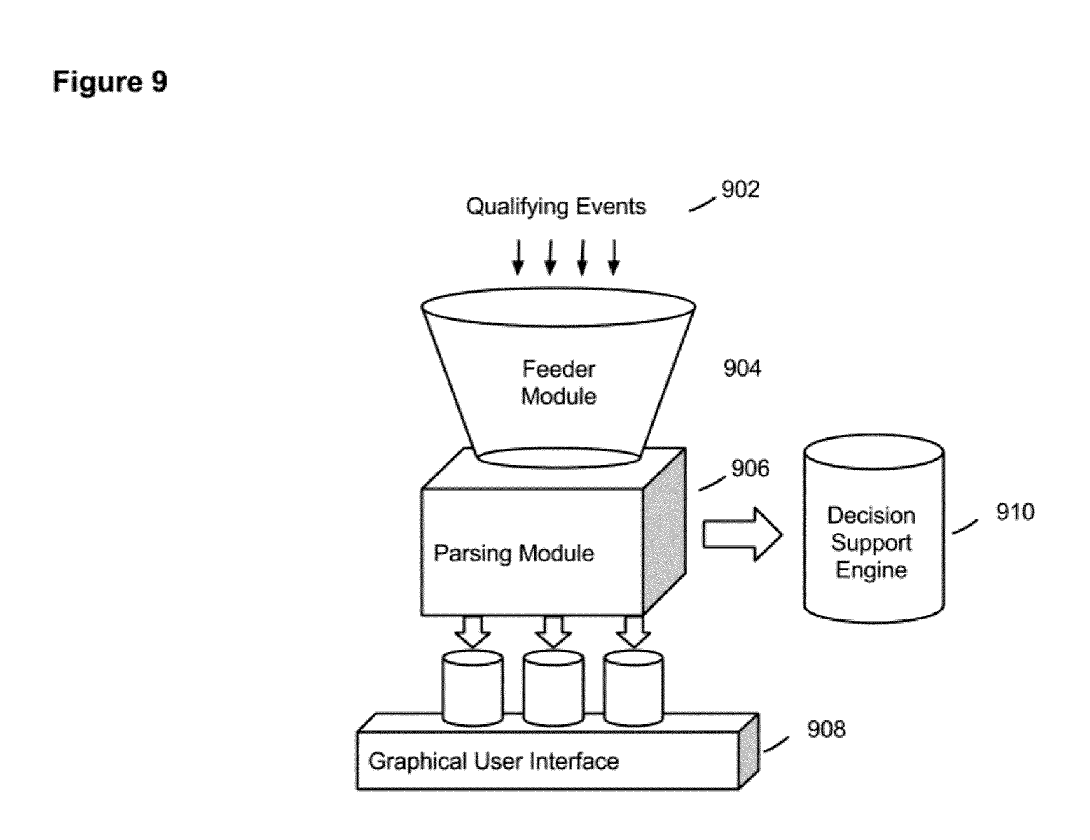

FIG. 9 illustrates a Feedback Module in accordance with the present invention. Referring to FIG. 9, a Qualifying Event 902 automatically triggers the initiation of the system indicating that a solicitation of, or response to, feedback is required. As contemplated herein, the Qualifying Event can be, for example, a new patient requesting an appointment; an established patient requesting an appointment; a patient referred to another provider completing an appointment; the Electronic Medical Record listing a service that has been completed; and certain responses to previous feedback requests indicating the need for further feedback requests. The user of the system could label any number of other interactions between the patient and a health care provider a Qualifying Event.

The Feedback Gathering Module 905 can comprise a processor configured to send a solicitation for feedback, generate questions based on data from the qualified event, and gather and send the data to the parsing module. Feedback requests are sent via the patient's preferred method of contact, such as email, text, or a secure communication from the clinical communication module (e.g., 208 in FIG. 2). Upon responding to a feedback request, the patient is directed to a secure page with questions generated for their feedback event. These questions can consist of general questions relevant to all events as well as questions designed for their specific event, such as questions dependent upon the specific specialty of a referral. The information filled out is sent securely to services where it is given to a Parsing Module 906 for processing.

Parsing Module 908 is a processor configured to receive data gathered from the qualifying event and perform qualitative and quantitative analysis on it. Relevant quantitative system criteria used in the decision support engine, such as a numerical representation of overall patient satisfaction with a provider, is recomputed with the new gathered data, with the system updating in real time. Qualitative data undergoes keyword analysis, looking for the types of words that may indicate poor review such as “didn't,” “failed,” “refused,” etc. The qualitative data receives a numeric score based on its perceived negativity. This numeric score is combined with the quantitative data to create an overall numeric score quantifying negativity of an experience. The practice or physician can configure the system to queue the response for immediate human review if it meets a certain threshold of negativity. This facilitates timely response to negative reviews and helps the practice or physician address the situation and potentially keep the negative reviews from being repeated outside of the platform.

A Graphical User Interface 908 is displayed on a platform dashboard/display with input capability and allows users of the system to see and interact with the feedback requests, responses, and data. Typically, this is where the practice manager or physician will be provided with an update as to the status of previously addressed items or those items that have been flagged for further review as discussed above.

In an alternative embodiment, feedback requests generated by the Feedback Gathering Module 904 may include, but are not limited to, the following questions: how long did it take to reach the office for communication; did you make a follow-up appointment; how far out was your first appointment; was the office staff friendly; was your physician friendly; did the care team provide answers to all of your questions; and how would you rate your satisfaction?

In another alternative embodiment, actionable data found through the risk profiling analysis performed by the Parsing Module 906 may include, but are not limited to, the following: a patient's failure to make an appointment with a specialist upon physician referral; a patient's failure to make a post-hospitalization follow-up appointment; a patient's failure to fill prescriptions for advised medications; a patient's reported experience with practitioners other than the patient's primary care provider; and a patient's indication of dissatisfaction with the quality or timeliness of care or communication delivered by a practitioner.

In still another alternative embodiment, the system may identify Qualifying Events by finding instances of feedback on third party websites.

The above-described steps can be implemented using standard well-known programming techniques. The novelty of the above-described embodiment lies not in the specific programming techniques but in the use of the steps described to achieve the described results. Software programming code which embodies the present invention is typically stored in non-transitory, permanent storage. In a client/server environment, such software programming code may be stored with storage associated with a server. The software programming code may be embodied on any of a variety of known non-transitory media for use with a data processing system, such as a diskette, or hard drive, or CD ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

The various modules described herein can comprise processor configured to perform the described functions and steps. It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

We claim:

1. An integrated referral management, clinical collaboration, and patient engagement platform, comprising:
a referring provider module, a referred provider module, and a patient module, interconnected with each other via a network connection;
a decision support engine coupled to the referring provider module, referred provider module, and patient module, said decision support engine identifying referral suggestions and outputting a list of said referral suggestions;
a workflow management module coupled to receive referral recommendations selected from the list of referral suggestions developed by said decision support module;
a performance analytics module coupled to the workflow management module, generating performance data based on performance of said referral recommendations; and
a feedback module coupled to receive patient feedback from the patient feedback module and generating patient feedback data;
said performance data and patient feedback data being routed into said decision support engine, whereby said decision support engine adjusts its referral suggestions in real time based on all inputs it receives.
